(19) United States
(12) Patent Application Publication
(10) Pub. No.: US 2022/0161615 A1
(43) Pub. Date: May 26, 2022

(54) SYSTEM AND METHOD FOR MOVING A WASTE CONTAINER

(71) Applicant: Gene Reese, Mays Landing, NJ (US)

(72) Inventor: Gene Reese, Mays Landing, NJ (US)

(21) Appl. No.: 17/531,842

(22) Filed: Nov. 22, 2021

Related U.S. Application Data
(60) Provisional application No. 63/118,184, filed on Nov. 25, 2020.

(51) Int. Cl. B60D 1/18

(52) U.S. Cl. CPC B60D 1/187; B60D 1/42

(57) ABSTRACT

A system and a method for moving one or more waste containers from a waste container staging location to a distant waste pick-up location are provided. At least one cable is disposed in a predefined configuration on a base of a trunk of a vehicle. A hitch member is in communication with the mid-section of the cable. The hitch member hitches the mid-section of the cable to the base of the trunk, with the opposing distal ends of the cable extending freely external to the trunk. Attachment members are attached to the opposing distal ends of the cable(s). Each attachment member detachably connects to a connection element of the waste container(s) at the waste container staging location, and allows the cable hitched to the trunk of the vehicle to pull and move the waste container(s) to the waste pick-up location when the vehicle is driven to the waste pick-up location.

### CROSS-REFERENCE TO RELATED APPLICATIONS

This application claims priority to and the benefit of the provisional patent application titled “System And Method For Moving Trash Cans”, application number 63/118,184, filed in the United States Patent and Trademark Office on Nov. 25, 2020. The specification of the above referenced patent application is incorporated herein by reference in its entirety.

### BACKGROUND

Curbside waste collection is a service provided typically in urban and suburban areas to residential homes, residential buildings, apartment buildings, commercial and business establishments, etc., where waste is generated by the occupants and needs to be disposed on a regular basis. The waste generated in these buildings is typically disposed in waste containers, for example, trash cans, wheelie bins, etc., which are thereafter manually moved and placed at a curb of a road near the home, building, etc. As used herein, curbside is a side of a street or other paved surface bordered by a curb. Curbside waste collection service personnel drive to the curb and transfer the waste from the waste containers into a waste collection vehicle, for example, a waste pick-up truck, for disposal at a waste disposal location, for example, a landfill, an incineration facility, a recycling facility, etc.

In some areas, a waste container staging location, for example, a location where one or more waste containers are stored or staged, is substantially distant from the location where the waste collection vehicle stops to pick up the waste from the waste container(s). For example, in rural areas, a person's house may be located at the end of a driveway, at a substantial distance from a road in front of the person's house where the waste pick-up truck stops to pick up waste from the person's house. Also, where the person is old, weak, or disabled, moving a waste container from the person's house to the road in front of the house where the waste pick-up truck stops to pick up the waste from the person's house is a difficult task.

Hence, there is a long-felt need for a system and a method for moving one or more waste containers from a waste container staging location, for example, a person's house, to a waste pick-up location distant from the waste container staging location, for example, a remote curbside of a road in front of the house, where the waste pick-up vehicle stops to pick up the waste from the waste container.

### SUMMARY

This summary is provided to introduce a selection of concepts in a simplified form that are further disclosed in the detailed description. This summary is not intended to determine the scope of the claimed subject matter.

The system and the method disclosed herein address the above-recited need for moving one or more waste containers from a waste container staging location, for example, a person's house, to a waste pick-up location distant from the waste container staging location, for example, a remote curbside of a road in front of the house, where a waste pick-up vehicle such as a waste pick-up truck stops to pick up the waste from the waste container. The system for moving one or more waste containers from a waste container staging location to a waste pick-up location distant from the waste container staging location is herein referred to as a waste moving system.

The waste moving system comprises at least one cable, a hitch member, and a pair of attachment members. The cable is disposed in a predefined configuration, for example, a U-shaped configuration, on a base of a trunk of a vehicle, for example, a car. The cable comprises opposing distal ends and a mid-section defined as a section about midway between the opposing distal ends. In an embodiment, the waste moving system further comprises an adjustment member positioned proximal to at least one of the opposing distal ends of the cable. The adjustment member is configured to adjust the length of the cable. The hitch member is in communication with the mid-section of the cable. The hitch member is configured to hitch the mid-section of the cable to the base of the trunk, with the opposing distal ends of the cable extending freely external to the trunk. In an embodiment, the hitch member is a spherical object, for example, a ball such as a tennis ball, with the mid-section of the cable in communication with the ball. The cable is secured to the base of the trunk of the vehicle by closing a lid of the trunk over the mid-section of the cable and sandwiching the cable between the lid of the trunk and the base of the trunk. In an embodiment, the waste moving system is free of the hitch member. In this embodiment, the cable is directly secured to the base of the trunk by closing the lid of the trunk over the mid-section of the cable and sandwiching the cable between the lid of the trunk and the base of the trunk, with the opposing distal ends of the cable extending freely external to the trunk.

The attachment members are attached to the opposing distal ends of the cable. The opposing distal ends of the cable are attached to the attachment members using fasteners. Each of the attachment members is configured to detachably connect to a connection element, for example, a handle, of the waste container(s) positioned at the waste container staging location and allow the cable hitched to the trunk of the vehicle to pull and move the waste container(s) from the waste container staging location to the waste pick-up location when the vehicle is driven to the waste pick-up location. In an embodiment, each of the attachment members is a hook-type attachment member comprising a latching gate configured to secure and preclude disengagement of the connection element of the waste container from the attachment members in a closed position. In an embodiment, the waste moving system further comprises a protective casing configured to enclose and protect each of the attachment members when the attachment members are not in use.

Disclosed herein is also a method for moving one or more waste containers from a waste container staging location to a waste pick-up location distant from the waste container staging location. The method disclosed herein provides the waste moving system comprising at least one cable, the hitch member, and the pair of attachment members as disclosed above. In the method disclosed herein, the cable is disposed in a predefined configuration, for example, a U-shaped configuration, on a base of a trunk of a vehicle. The mid-section of the cable is disposed on the base of the trunk, with the opposing distal ends of the cable extending freely external to the trunk. In an embodiment, the length of the cable is adjusted using the adjustment member positioned proximal to at least one of the opposing distal ends of the cable. The hitch member hitches the mid-section of the cable to the base of the trunk. The cable is secured to the base of the trunk of the vehicle by closing a lid of the trunk over the hitched mid-section of the cable and sandwiching the cable between the lid of the trunk and the base of the trunk. When the lid of the trunk is in a closed position, the hitch member is positioned flush against an inner surface of the lid and the base of the trunk, thereby hitching the mid-section of the cable to the base of the trunk. In an embodiment, the cable is directly secured to the base of the trunk, without the hitch member, by closing the lid of the trunk over the mid-section of the cable and sandwiching the cable between the lid of the trunk and the base of the trunk. In this embodiment, the mid-section of the cable extends freely inside the trunk, with the opposing distal ends of the cable extending freely external to the trunk. In the method disclosed herein, each of the attachment members is then securely connected to a connection element of a waste container(s), for example, a wheelie bin containing waste, positioned at the waste container staging location. When the vehicle is driven to the waste pick-up location, the cable hitched to the trunk of the vehicle pulls and moves the waste container(s) from the waste container staging location to the waste pick-up location.

### BRIEF DESCRIPTION OF THE DRAWINGS

The foregoing summary, as well as the following detailed description, is better understood when read in conjunction with the appended drawings. For illustrating the embodiments herein, exemplary constructions of the embodiments are shown in the drawings. However, the embodiments herein are not limited to the specific structures, components, and methods disclosed herein. The description of a structure, or a component, or a method step referenced by a numeral in a drawing is applicable to the description of that structure, component, or method step shown by that same numeral in any subsequent drawing herein.

FIG. 1A exemplarily illustrates a top view of an embodiment of a waste moving system for moving one or more waste containers from a waste container staging location to a waste pick-up location distant from the waste container staging location.

FIG. 1B exemplarily illustrates a bottom view of the waste moving system shown in FIG. 1A.

FIG. 1C exemplarily illustrates a top view of the waste moving system, showing a latching gate of each of a pair of attachment members of a first type in an open position.

FIG. 2A exemplarily illustrates a top view of an embodiment of the waste moving system with a latching gate of each of a pair of attachment members of a second type in an open position.

FIG. 2B exemplarily illustrates a top view of the waste moving system with the latching gate of each of the attachment members of the second type in a closed position.

FIG. 3 exemplarily illustrates a top view of an embodiment of the waste moving system, showing an adjustment member positioned proximal to a distal end of a cable of the waste moving system.

FIG. 4 exemplarily illustrates a top view of an embodiment of the waste moving system, showing a protective casing for protecting each of the attachment members of the waste moving system.

FIGS. 5A-5F exemplarily illustrate a schematic embodiment of a method for moving a waste container from a waste container staging location to a waste pick-up location distant from the waste container staging location.

FIG. 6A exemplarily illustrates a top view of another embodiment of the waste moving system, showing a latching gate of each of a pair of attachment members of the first type in a closed position.

FIG. 6B exemplarily illustrates a bottom view of the waste moving system shown in FIG. 6A.

FIG. 6C exemplarily illustrates a top view of the waste moving system shown in FIG. 6A, showing the latching gate of each of the attachment members of the first type in an open position.

FIG. 7A exemplarily illustrates a top view of an embodiment of the waste moving system, showing a latching gate of each of a pair of attachment members of the second type in an open position.

FIG. 7B exemplarily illustrates a top view of the waste moving system, showing the latching gate of each of the attachment members of the second type in a closed position.

FIGS. 8A-8B exemplarily illustrate a schematic embodiment of a method for moving a waste container from a waste container staging location to a waste pick-up location distant from the waste container staging location.

FIG. 9 illustrates a flowchart of a method for moving one or more waste containers from a waste container staging location to a waste pick-up location distant from the waste container staging location.

### DETAILED DESCRIPTION

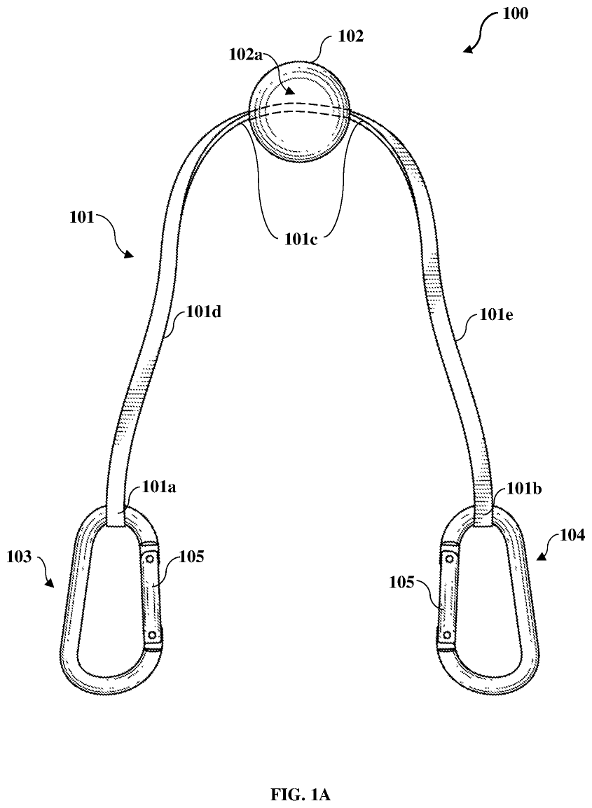

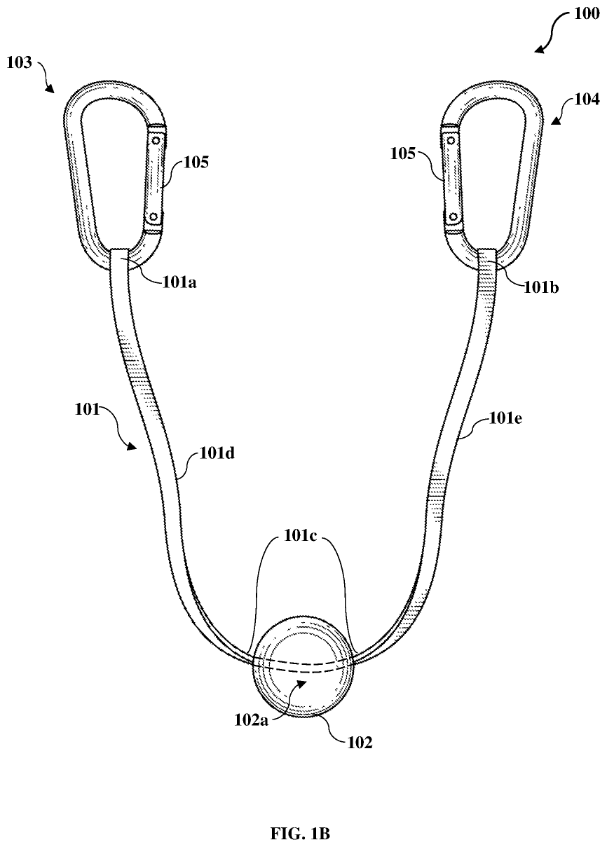

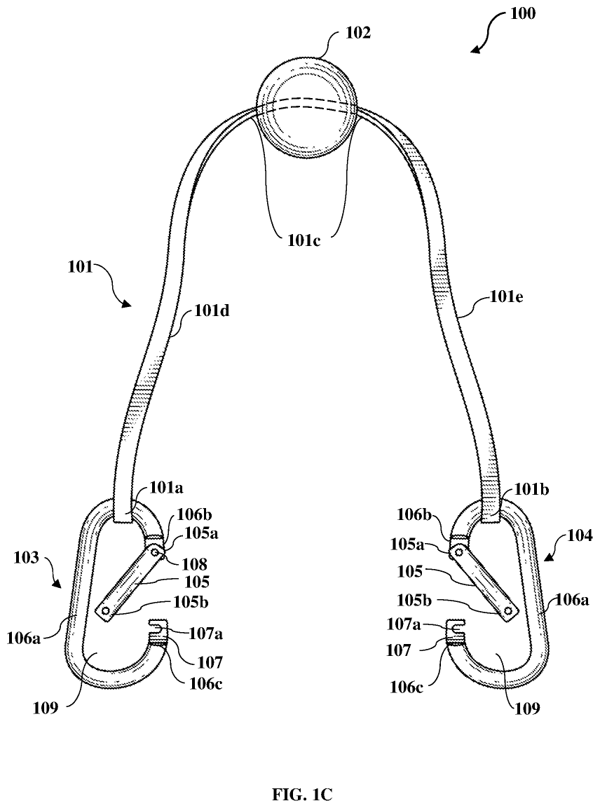

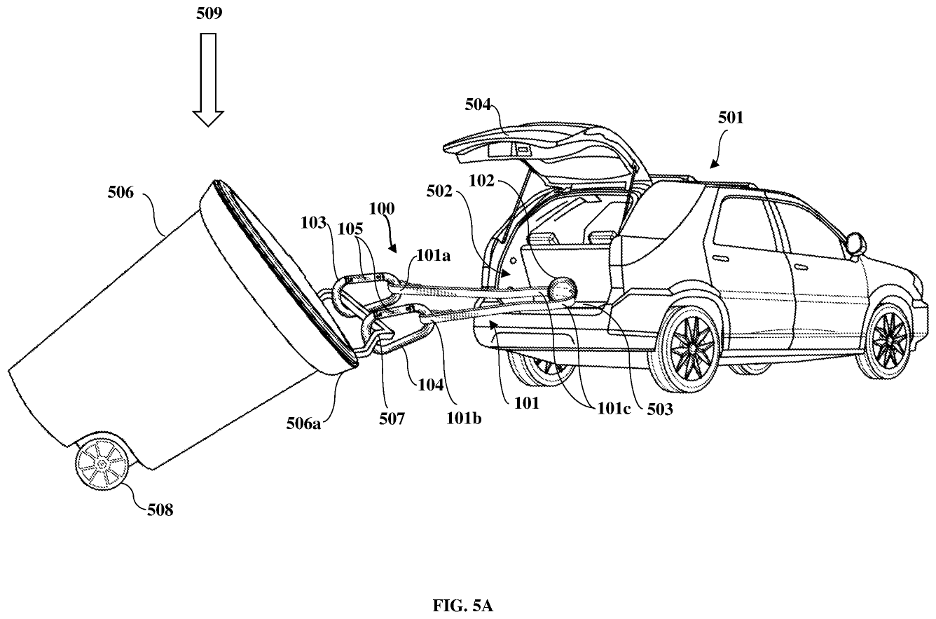

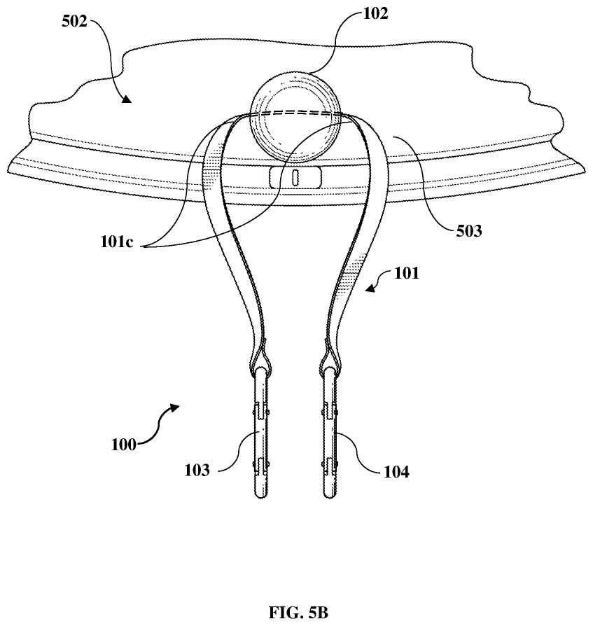

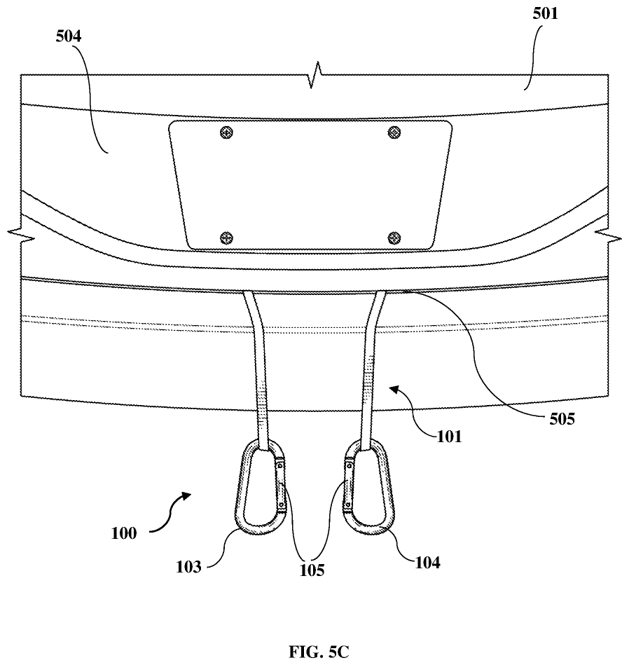

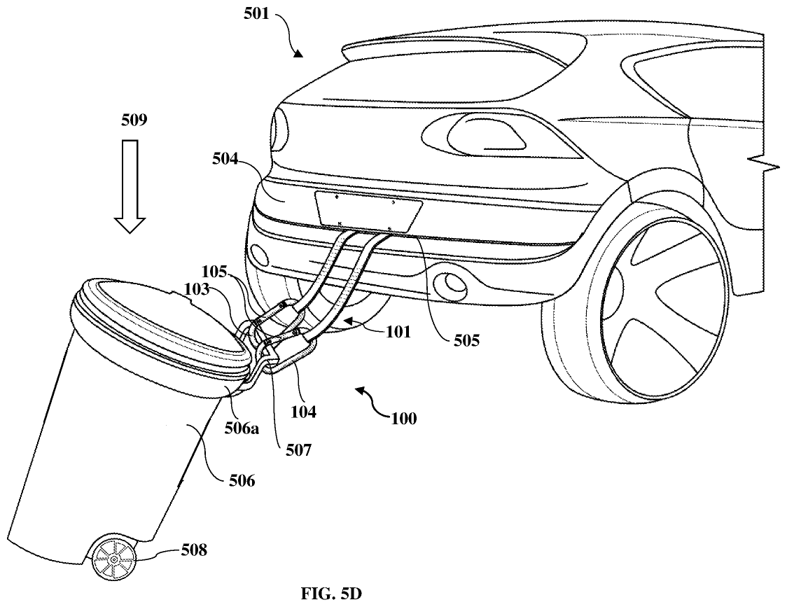

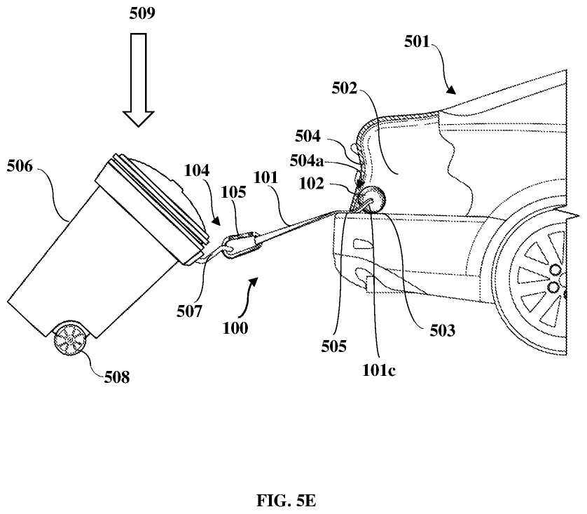

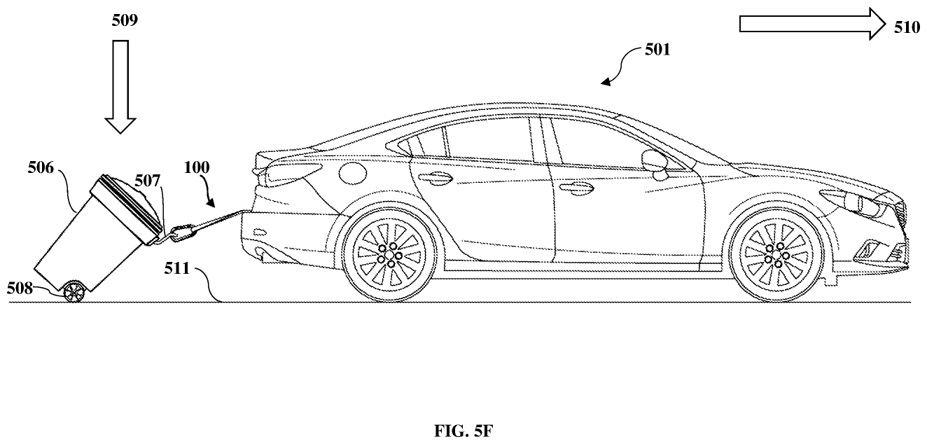

FIGS. 1A-1B exemplarily illustrate a top view and a bottom view respectively, of an embodiment of a waste moving system 100 for moving one or more waste containers 506 from a waste container staging location 509 to a waste pick-up location 510 distant from the waste container staging location 509 shown in FIG. 5F. As used herein, “waste container staging location” refers to a location where one or more waste containers 506 are stored or staged. For example, the waste container staging location 509 is a person's house located at the end of a driveway, at a substantial distance from a road in front of the person's house where a waste pick-up vehicle such as a waste pick-up truck stops to pick up waste from the person's house. Other waste container staging locations 509 comprise, for example, residential buildings and other buildings or structures where waste is disposed. Also, as used herein, “waste pick-up location” refers to a location where a waste pick-up vehicle such as a waste pick-up truck stops to pick up waste from the waste containers 506 staged in the waste container staging location 509. In rural areas, for example, the waste pick-up location 510 is distant from the waste container staging location 509. In an example, the waste pick-up location 510 is a remote curbside of a road in front of a person's house, where a waste pick-up truck stops to pick up the waste from one or more waste containers 506. Curbside waste collection service personnel drive to the waste pick-up location 510 such as a curb, and transfer the waste from the waste containers 506 into a waste pick-up vehicle, for example, a waste pick-up truck, for disposal at a waste disposal location, for example, a landfill, an incineration facility, a recycling facility, etc. Also, as used herein, “waste container” refers to a container, for example, a bin, a trash can, a garbage bin, a wheelie bin, etc., where waste matter is disposed. The system 100 for moving one or more waste containers 506 from the waste container staging location 509 to the waste pick-up location 510 distant from the waste container staging location 509 is herein referred to as a waste moving system 100.

In an embodiment, the waste moving system 100 comprises at least one cable 101, a hitch member 102, and a pair of attachment members 103 and 104 as exemplarily illustrated in FIGS. 1A-1B. In an embodiment, the cable 101 is arranged in a predefined configuration, for example, a U-shaped configuration, as exemplarily illustrated in FIGS. 1A-1B. The cable 101 is a strap-like structure made of a strong material, for example, nylon, a plastic, etc. The cable 101 comprises opposing distal ends 101a and 101b and a mid-section 101c defined as a section about mid-way between the opposing distal ends 101a and 101b. The hitch member 102 is in communication with the mid-section 101c of the cable 101. In an embodiment, one end 101a or 101b of the cable 101 is inserted about diametrically through the center 102a of the hitch member 102 and pulled therethrough to position the hitch member 102 at the mid-section 101c of the cable 101, with the opposing ends 101a and 101b of the cable 101 extending freely in opposing directions from the center 102a of the hitch member 102, as exemplarily illustrated in FIGS. 1A-1B. The hitch member 102 is configured to hitch the mid-section 101c of the cable 101 to a base 503 of a trunk 502 of a vehicle 501, for example, a car exemplarily illustrated in FIG. 5A and FIG. 5E, with the opposing distal ends 101a and 101b of the cable 101 extending freely external to the trunk 502 as exemplarily illustrated in FIGS. 5A-5F. The hitch member 102 is configured to maintain a separation between sections 101d and 101e of the cable 101 that extend to the opposing distal ends 101a and 101b as exemplarily illustrated in FIGS. 1A-1B. The hitch member 102 also ensures the sections 101d and 101e of the cable 101 remain secured to the base 503 of the trunk 502 of the vehicle 501, when the vehicle 501 tows the waste container 506 from the waste container staging location 509 towards the waste pick-up location 510. In an embodiment, the hitch member 102 is a spherical object, for example, a ball such as a tennis ball, in communication with the mid-section 101c of the cable 101. The mid-section 101c of the cable 101 is disposed about diametrically through the center 102a of the hitch member 102. The material of the hitch member 102, is, for example, rubber, wood, plastic, etc. The cable 101 is secured to the base 503 of the trunk 502 of the vehicle 501 by closing a lid 504 of the trunk 502 over the mid-section 101c of the cable 101 and sandwiching the cable 101 between the lid 504 of the trunk 502 and the base 503 of the trunk 502 as exemplarily illustrated in FIGS. 5C-5F.

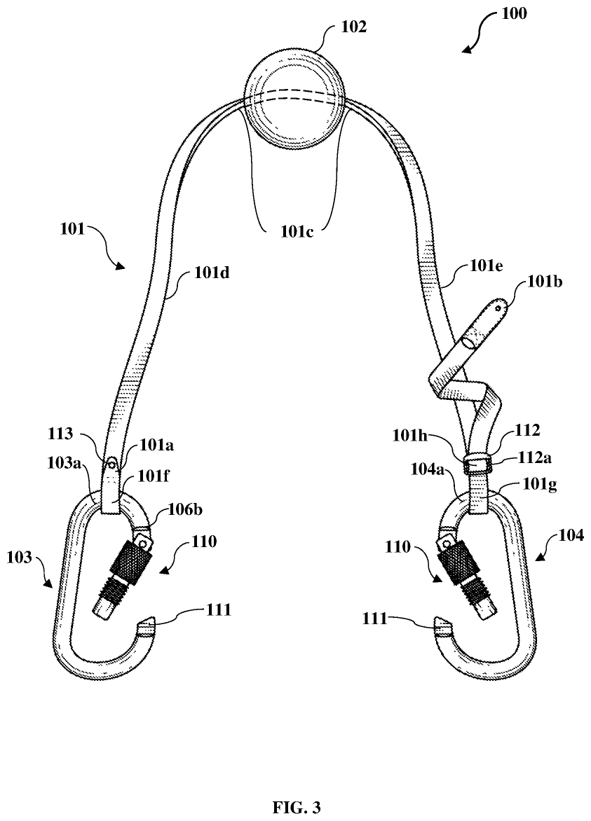

As exemplarily illustrated in FIGS. 1A-1B, the attachment members 103 and 104 are attached to the opposing distal ends 101a and 101b of the cable 101, respectively. The attachment members 103 and 104 are made, for example, from aluminum, steel, metal alloys, etc. The opposing distal ends 101a and 101b of the cable 101 are attached to the attachment members 103 and 104 using fasteners as disclosed in the detailed description of FIG. 3. Each of the attachment members 103 and 104 is configured to detachably connect to a connection element 507, for example, a handle or a slot, of a waste container 506 positioned at the waste container staging location 509 exemplarily illustrated in FIG. 5A and FIGS. 5D-5F, and allow the cable 101 hitched to the trunk 502 of the vehicle 501 to pull and move the waste container 506 from the waste container staging location 509 to the waste pick-up location 510, when the vehicle 501 is driven to the waste pick-up location 510 as exemplarily illustrated in FIG. 5F. In an embodiment, each of the attachment members 103 and 104 is a hook-type attachment member of a first type, for example, a carabiner, comprising a latching gate 105 configured to secure and preclude disengagement of the connection element 507 of the waste container 506 from the attachment members 103 and 104 in a closed position. The latching gate 105 in the closed position is exemplarily illustrated in FIGS. 1A-1B.

FIG. 1C exemplarily illustrates a top view of the waste moving system 100, showing the latching gate 105 of each of a pair of attachment members 103 and 104 of the first type in an open position. In an embodiment, the attachment members 103 and 104 are carabiners configured to securely and reversibly connect the waste moving system 100 to the connection element 507 of a waste container 506 as exemplarily illustrated in FIG. 5A and FIGS. 5D-5F. Each of the attachment members 103 and 104 is, for example, an oval-shaped, a pear-shaped, an asymmetric D-shaped, or a D-shaped ring or loop made of metal with the latching gate 105 on one side. As exemplarily illustrated in FIG. 1C, each of the attachment members 103 and 104 comprises the latching gate 105, a nose 107, and a spine 106a curvedly defined between opposing ends 106b and 106c of the respective attachment member 103 or 104. The latching gate 105 is, for example, a metal bar. The latching gate 105 is hinged to the opposing end 106b of the respective attachment member 103 or 104 using a fastener 108, for example, a rivet pin. The nose 107 of each of the attachment members 103 and 104 extends from the opposing end 106c of the respective attachment member 103 or 104.

The latching gate 105 closes each of the attachment members 103 and 104 as exemplarily illustrated in FIGS. 1A-1B, and in turn, secures the connection element 507 of the waste container 506 received within a space 109 defined by each of the attachment members 103 and 104 as exemplarily illustrated in FIG. 5A and FIGS. 5D-5F, ensuring that the connection element 507 is secured by the attachment members 103 and 104. The latching gate 105 comprises a first end 105a and a second end 105b. The first end 105a of the latching gate 105 is hinged to the opposing end 106b of the respective attachment member 103 or 104 using the fastener 108. The latching gate 105 pivots about the fastener 108. The second end 105b of the latching gate 105 is detachably connected to the nose 107 of the respective attachment member 103 or 104. In an embodiment as exemplarily illustrated in FIG. 1C, the nose 107 comprises a notch 107a configured to securely engage with the second end 105b of the latching gate 105. In an embodiment as exemplarily illustrated in FIGS. 1A-1C, the latching gate 105 of the first type of each of the attachment members 103 and 104 is a straight gate configured as a straight bar from the first end 105a to the second end 105b. In other embodiments (not shown), the latching gate 105 is configured, for example, as a bent gate or a wire gate.

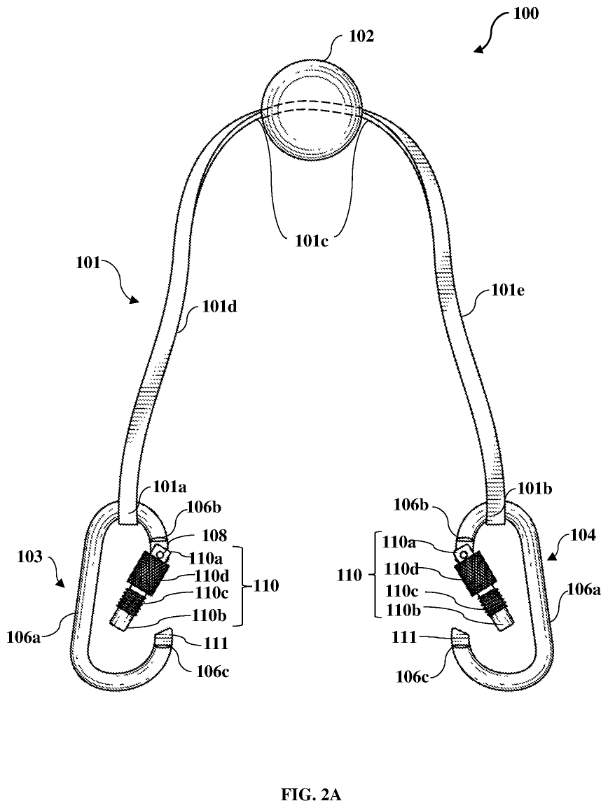

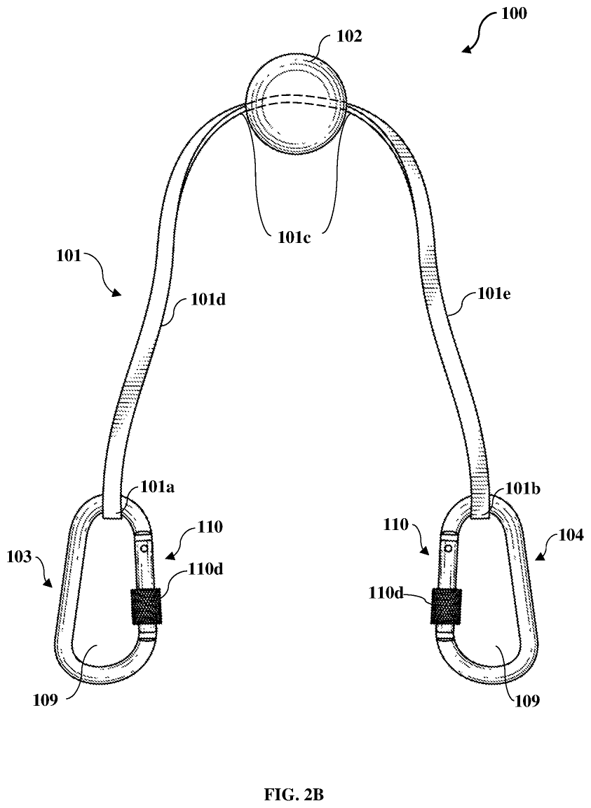

FIG. 2A exemplarily illustrates a top view of an embodiment of the waste moving system 100 with a latching gate 110 of each of a pair of attachment members 103 and 104 of a second type in an open position. In this embodiment, the attachment members 103 and 104 of the second type are, for example, screw-type locking carabiners. Each of the attachment members 103 and 104 is, for example, an oval-shaped, a pear-shaped, an asymmetric D-shaped, or a D-shaped ring or loop made of metal with the latching gate 110 on one side. As exemplarily illustrated in FIG. 2A, each of the attachment members 103 and 104 comprises the latching gate 110, a nose 111, and a spine 106a curvedly defined between opposing ends 106b and 106c of the respective attachment member 103 or 104. The latching gate 110 is hinged to the opposing end 106b of the respective attachment member 103 or 104 using a fastener 108, for example, a rivet pin. The nose 111 of each of the attachment members 103 and 104 extends from the opposing end 106c of the respective attachment member 103 or 104.

In an embodiment, the latching gate 110 of the second type of each of the attachment members 103 and 104 is a screw-type locking gate comprising a first end 110a, a second end 110b, a threaded section 110c, and a locking sleeve or barrel 110d. The first end 110a of the latching gate 110 is hinged to the opposing end 106b of the respective attachment member 103 or 104 using the fastener 108. The latching gate 110 pivots about the fastener 108. The second end 110b of the latching gate 110 is detachably connected to the nose 111 of the respective attachment member 103 or 104. In this embodiment, the latching gate 110 is closed by engaging the second end 110b of the latching gate 110 with the nose 111 and manually screwing the locking sleeve 110d over the threaded section 110c of the latching gate 110 till the locking sleeve 110d reaches the opposing end 106c of the respective attachment member 103 or 104 as exemplarily illustrated in FIG. 2B. In another embodiment, the latching gate 110 is a spring-loaded gate configured to automatically close each of the attachment members 103 and 104 when the latching gate 110 is released. In another embodiment, the latching gate 110 is a magnetic locking gate.

FIG. 2B exemplarily illustrates a top view of the waste moving system 100 with the latching gate 110 of each of the attachment members 103 and 104 of the second type in a closed position. The latching gate 110 closes each of the attachment members 103 and 104 as exemplarily illustrated in FIG. 2B, and in turn, secures the connection element 507 of the waste container 506 received within a space 109 defined by each of the attachment members 103 and 104 as exemplarily illustrated in FIG. 5A and FIGS. 5D-5F, ensuring that the connection element 507 of the waste container 506 is secured by the attachment members 103 and 104. If the latching gate 110 is spring-loaded, the latching gate 110 pivots to the closed position due to a return force of a spring (not shown) contained therewithin and locks the connection element 507, thereby connecting the attachment members 103 and 104, and in turn, the waste moving system 100 to the waste container 506.

For purposes of illustration, the detailed description herein refers to the attachment members 103 and 104 being carabiners of the first type and the second type as disclosed in the detailed descriptions of FIGS. 1A-1C and FIGS. 2A-2B respectively; however, the scope of the waste moving system 100 is not limited to the attachment members 103 and 104 being carabiners of the first type and the second type, but may be extended to include maillons, snap hook clips, metal links, and other functionally equivalent attachment members configured to securely connect and fasten the waste moving system 100 to one or more connection elements 507 of one or more waste containers 506.

FIG. 3 exemplarily illustrates a top view of an embodiment of the waste moving system 100, showing an adjustment member 112 positioned proximal to a distal end 101b of the cable 101 of the waste moving system 100. The opposing distal ends 101a and 101b of the cable 101 are attached to the attachment members 103 and 104 using fasteners 113, for example, rivets. For example, the opposing distal ends 101a and 101b of the cable 101 are folded over portions 103a and 104a of the attachment members 103 and 104 respectively, to form tabs 101f and 101g that are secured around the portions 103a and 104a of the attachment members 103 and 104 respectively, using fasteners 113, for example, rivets. In an embodiment, the waste moving system 100 further comprises an adjustment member 112 positioned proximal to at least one of the opposing distal ends 101a and 101b of the cable 101. For example, the adjustment member 112 is positioned proximal to the distal end 101b of the cable 101 as exemplarily illustrated in FIG. 3. The adjustment member 112 is configured to adjust a length of the cable 101. The adjustment member 112 is, for example, an adjustable slide buckle that slides on the surface of the cable 101 and provides a firm locking grip on the surface of the cable 101 when the desired length of the cable 101 is achieved.

As exemplarily illustrated in FIG. 3, a portion 101g of the cable 101 extending from the adjustment member 112 is folded over a portion 104a of the attachment member 104, and the distal end 101b of the cable 101 is used to adjust the length of the cable 101 via the adjustment member 112. The adjustment member 112 comprises one or more center bars 112a over which a portion 101h of the cable 101 is run during adjustment of the length of the cable 101. In an embodiment, the center bar(s) 112a of the adjustment member 112 is a rolling pin that allows rolling of the cable 101 thereon and in turn, convenient adjustment of the length of the cable 101. The adjustment member 112 is configured in one of different shapes, for example, a rectangular shape as exemplarily illustrated in FIG. 3. The dimensions of the adjustment member 112 are configured based on the width and the thickness of the cable 101. The adjustment member 112 is made, for example, from a metal such as steel or aluminum, a metal alloy such as stainless steel, plastic, etc. The adjustment member 112 is configured to adjust the length of the cable 101, for example, from about 25 inches to about 55 inches.

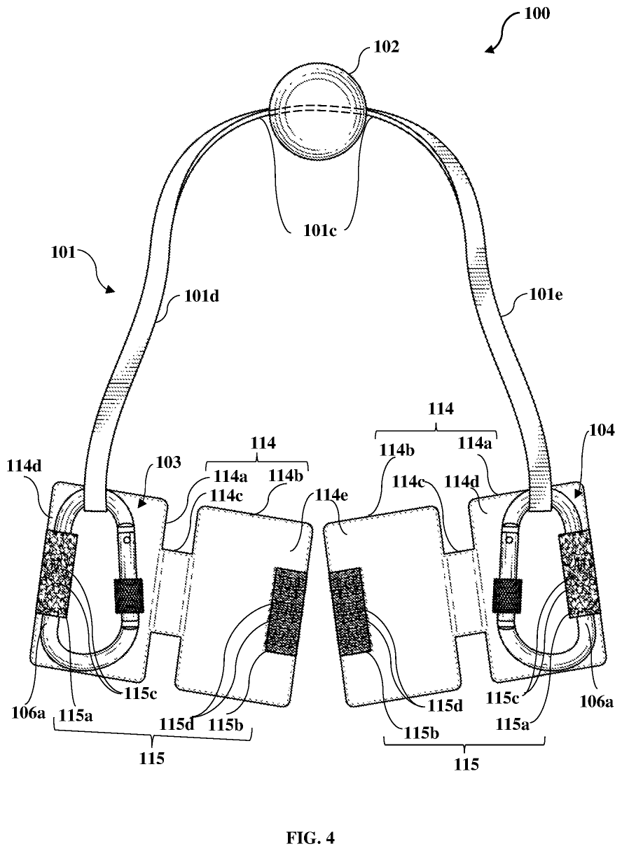

FIG. 4 exemplarily illustrates a top view of an embodiment of the waste moving system 100, showing a protective casing 114 for protecting each of the attachment members 103 and 104 of the waste moving system 100. The protective casing 114 is configured to enclose and protect each of the attachment members 103 and 104 when the attachment members 103 and 104 are not in use. The protective casing 114 protects each of the attachment members 103 and 104 from ambient elements, for example, dust, moisture, and other elements that may damage or erode the attachment members 103 and 104 over time. In an embodiment, the protective casing 114 is configured as a flip cover comprising a first covering section 114a, a second covering section 114b, and a spine 114c configured to hinge the first covering section 114a to the second covering section 114b. In an embodiment, the second covering section 114b is detachably attached to the first covering section 114a using a fastener, for example, a hook and loop fastener 115 such as a Velcro® fastener.

The hook and loop fastener 115 comprises two fabric strips 115a and 115b attached to opposing inner surfaces 114d and 114e of the first covering section 114a and the second covering section 114b of the protective casing 114 respectively. In an example, the fabric strip 115a on the inner surface 114d of the first covering section 114a comprises loops 115c of the hook and loop fastener 115, while the fabric strip 115b on the inner surface 114e of the second covering section 114b comprises hooks 115d of the hook and loop fastener 115 as illustrated in FIG. 4. In another example, the hooks 115d and the loops 115c of the hook and loop fastener 115 are interchangeably configured on the fabric strips 115a and 115b. When the fabric strip 115a of the first covering section 114a is pressed against the fabric strip 115b of the second covering section 114b, the hooks 115d on the fabric strip 115b engage the loops 115c on the fabric strip 115a for attaching the first covering section 114a to the second covering section 114b. The first covering section 114a is separated from the second covering section 114b by pulling or peeling the two fabric strips 115a and 115b apart. As exemplarily illustrated in FIG. 4, each of the attachment members 103 and 104 is positioned on the first covering section 104a of the protective casing 114. The fabric strip 115a attaches the spine 106a of each of the attachment members 103 and 104 to the inner surface 114d of the first covering section 114a. The fabric strip 115b of the second covering section 114b is then pressed against the fabric strip 115a of the first covering section 114a to encase and protect each of the attachment members 103 and 104. The protective casing 114 is configurable in different shapes based on the shape of the attachment members 103 and 104. The first covering section 114a and the second covering section 114b of the protective casing 114 are, for example, of rectangular shapes as exemplarily illustrated in FIG. 4. The dimensions of the protective casing 114 are slightly larger than the dimensions of the attachment members 103 and 104 to optimally protect the attachment members 103 and 104. The protective casing 114 is made, for example, from plastic, rubber, silicone, or other protective materials.

FIGS. 5A-5F exemplarily illustrate a schematic embodiment of a method for moving a waste container 506, for example, a wheelie bin, from a waste container staging location 509 to a waste pick-up location 510 distant from the waste container staging location 509. As exemplarily illustrated in FIG. 5A, the cable 101 of the waste moving system 100 is disposed in a predefined configuration, for example, a U-shaped configuration, on a base 503 of a trunk 502 of a vehicle 501, for example, a car. The hitch member 102, for example, a ball such as a tennis ball, of the waste moving system 100 hitches the mid-section 101c of the cable 101 to the base 503 of the trunk 502 with the opposing distal ends 101a and 101b of the cable 101 with the attachment members 103 and 104 of the waste moving system 100 respectively, extending freely external to the trunk 502 as exemplarily illustrated in FIGS. 5A-5B. By closing the lid 504 of the trunk 502 over the mid-section 101c of the cable 101, and sandwiching the cable 101 between the lid 504 of the trunk 502 and the base 503 of the trunk 502, the cable 101 is secured to the base 503 of the trunk 502 as exemplarily illustrated in FIG. 5C. A sandwich interface 505 created by closing the lid 504 of the trunk 502 over the mid-section 101c of the cable 101 is exemplarily illustrated in FIGS. 5C-5D. When the lid 504 of the trunk 502 is closed, the cable 101 is securely fixed to the vehicle 501.

Each of the attachment members 103 and 104 is detachably connected to a connection element 507, for example, a slotted handle, of a waste container 506 positioned at the waste container staging location 509 as exemplarily illustrated in FIG. 5A and FIGS. 5D-5F. The connection element 507 is disposed, for example, at an upper end 506a of the waste container 506. The latching gate 105 of each of the attachment members 103 and 104 is pivoted to an open position, thereby allowing the nose 107 of each of the attachment members 103 and 104 exemplarily illustrated in FIG. 1C, to hook onto the connection element 507 of the waste container 506. After hooking the nose 107 of each of the attachment members 103 and 104 onto the connection element 507 of the waste container 506, the latching gate 105 of each of the attachment members 103 and 104 is pivoted to a closed position, thereby securing the attachment members 103 and 104 to the connection element 507 of the waste container 506. In an embodiment, the latching gate 105, when released, automatically closes each of the attachment members 103 and 104.

As exemplarily illustrated in FIG. 5E, when the lid 504 of the trunk 502 is in a closed position, the hitch member 102 is positioned flush against an inner surface 504a of the lid 504 and the base 503 of the trunk 502, thereby hitching the mid-section 101c of the cable 101 to the base 503 of the trunk 502. As exemplarily illustrated in FIG. 5E, the opposing distal ends 101a and 101b of the cable 101 with their attachment members 103 and 104 respectively, extend external to the trunk 502 outside the sandwich interface 505, with the hitch member 102 in communication with the mid-section 101c of the cable 101 being disposed inside the trunk 502 of the vehicle 501. The cable 101 is securely fixed to the vehicle 501 at the sandwich interface 505, and the attachment members 103 and 104 are securely fixed to the connection element 507 of the waste container 506 with respective latching gates 105, thereby ensuring that when the vehicle 501 is driven and moved, the waste container 506 is towed along with the moving vehicle 501.

The vehicle 501, with the waste container 506 in tow, is thereafter started and moved towards the waste pick-up location 510, for example, where a waste pick-up truck (not shown) parks on the road curbside to pick up and empty out the waste from the waste container 506. Connecting the attachment members 103 and 104 to the connection element 507 of the waste container 506 allows the cable 101 hitched to the trunk 502 of the vehicle 501 to pull and move the waste container 506 from the waste container staging location 509 to the waste pick-up location 510, when the vehicle 501 is driven to the waste pick-up location 510 as exemplarily illustrated in FIG. 5F. The wheels 508 of the waste container 506 allow the vehicle 501 to tow the waste container 506 on a road 511 towards the waste pick-up location 510 as exemplarily illustrated in FIG. 5F. When the driver of the vehicle 501 reaches the waste pick-up location 510, the latching gate 105 of each of the attachment members 103 and 104 is unfastened from the connection element 507 of the waste container 506. The waste from the waste container 506 parked at the road curbside is thereafter picked up and transferred to the waste pick-up truck by a waste pick-up truck driver.

In an embodiment, any one of the attachment members 103 and 104 is used to connect the waste moving system 100 to the connection element 507 of the waste container 506. In another embodiment, more than one cable 101 with their respective attachment members 103 and 104 is used to connect the waste moving system 100 to more than one waste container 506, thereby allowing multiple waste containers 506 to be moved, by the driven vehicle 501, from the waste container staging location 509 to the waste pick-up location 510.

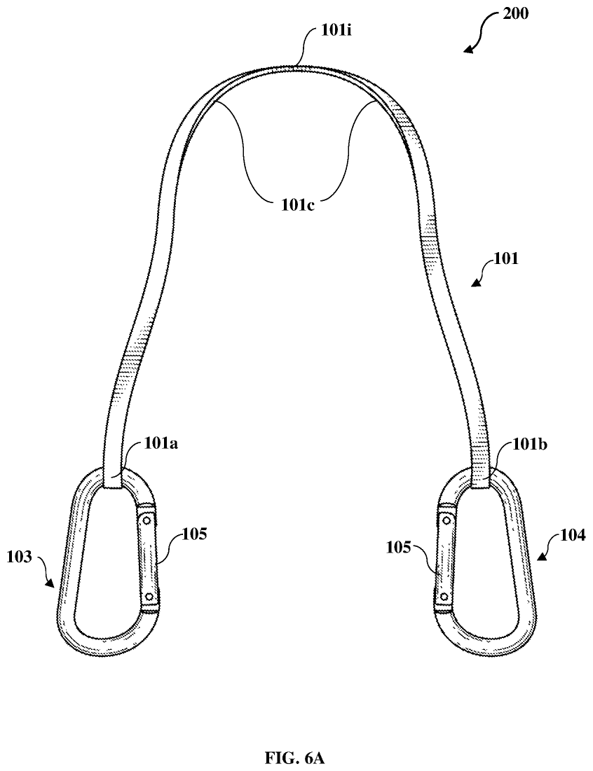

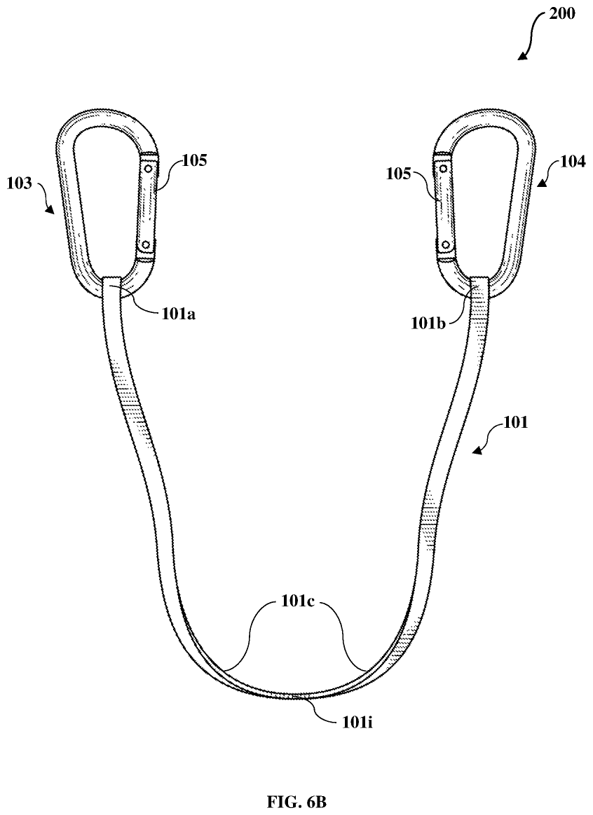

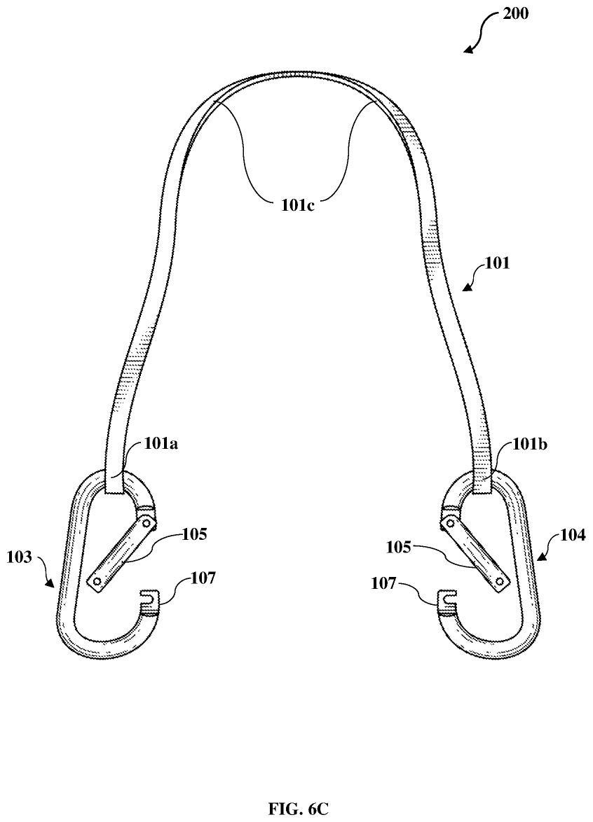

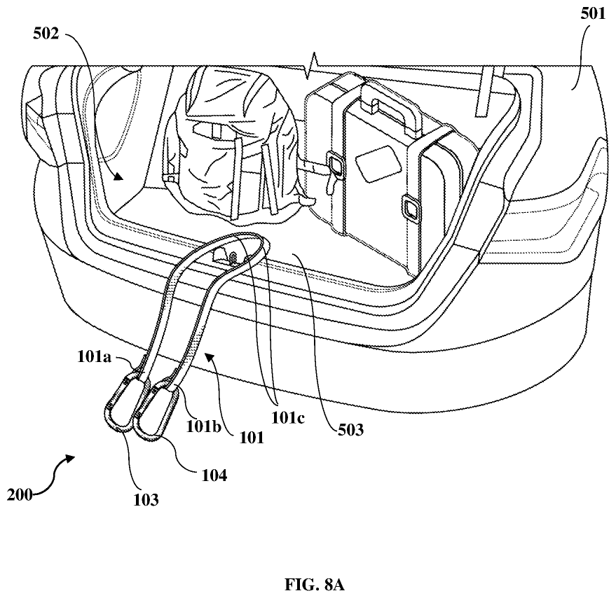

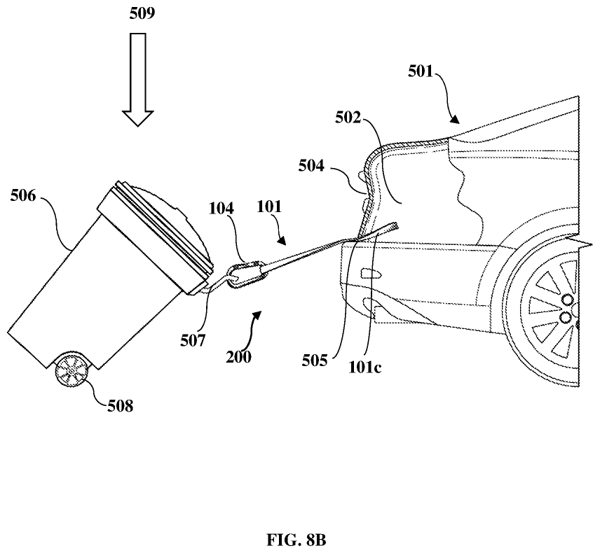

FIGS. 6A-6B exemplarily illustrate a top view and a bottom view respectively, of another embodiment of the waste moving system 200, showing a latching gate 105 of each of a pair of attachment members 103 and 104 of the first type in a closed position. In this embodiment, the waste moving system 200 does not comprise the hitch member 102, for example, the ball, of the waste moving system 100 disclosed in the detailed descriptions of FIGS. 1A-5F. In this embodiment, the cable 101 of the waste moving system 200 is arranged in a predefined configuration, for example, a U-shaped configuration, as exemplarily illustrated in FIGS. 6A-6C. The cable 101 comprises opposing distal ends 101a and 101b and a mid-section 101c defined as a section about midway between the opposing distal ends 101a and 101b as disclosed in the detailed description of FIGS. 1A-1B. In this embodiment, the cable 101 is directly secured to the base 503 of the trunk 502 by closing the lid 504 of the trunk 502 over the mid-section 101c of the cable 101 and sandwiching the cable 101 between the lid 504 of the trunk 502 and the base 503 of the trunk 502, with the opposing distal ends 101a and 101b of the cable 101 extending freely external to the trunk 502 as exemplarily illustrated in FIGS. 8A-8B.

The attachment members 103 and 104 are attached to the opposing distal ends 101a and 101b of the cable 101 respectively, as disclosed in the detailed description of FIGS. 1A-1B. In an embodiment, each of the attachment members 103 and 104 is a hook-type attachment member of a first type, for example, a carabiner, comprising a latching gate 105 configured to secure and preclude disengagement of the connection element 507 of the waste container 506 from the attachment members 103 and 104 in a closed position as disclosed in the detailed description of FIGS. 1A-1C.

In an embodiment (not shown), the waste moving system 200 comprises multiple cables 101 tied together, for example, at a center point 101i of the mid-section 101c of each of the cables 101 exemplarily illustrated in FIGS. 6A-6B, to allow connection to multiple waste containers 506 via respective attachment members 103 and 104. The center point 101i of the mid-section 101c of each of the cables 101 is tied together, for example, using one or more cable ties (not shown). In an example, the waste moving system 200 comprises two cables 101 for towing two waste containers 506, where the attachment members 103 and 104 at the opposing distal ends 101a and 101b of the second cable 101 respectively, are connected to a second waste container 506 in the same manner as the attachment members 103 and 104 at the opposing distal ends 101a and 101b of the first cable 101 are connected to the first waste container 506 exemplarily illustrated in FIGS. 8A-8B.

FIG. 6C exemplarily illustrates a top view of the waste moving system 200 shown in FIG. 6A, showing the latching gate 105 of each of the attachment members 103 and 104 of the first type in an open position. The pivotable movement of the latching gate 105 for opening and closing each of the attachment members 103 and 104 by disengaging and engaging with the nose 107 of each of the attachment members 103 and 104 respectively is disclosed in the detailed description of FIG. 1C.

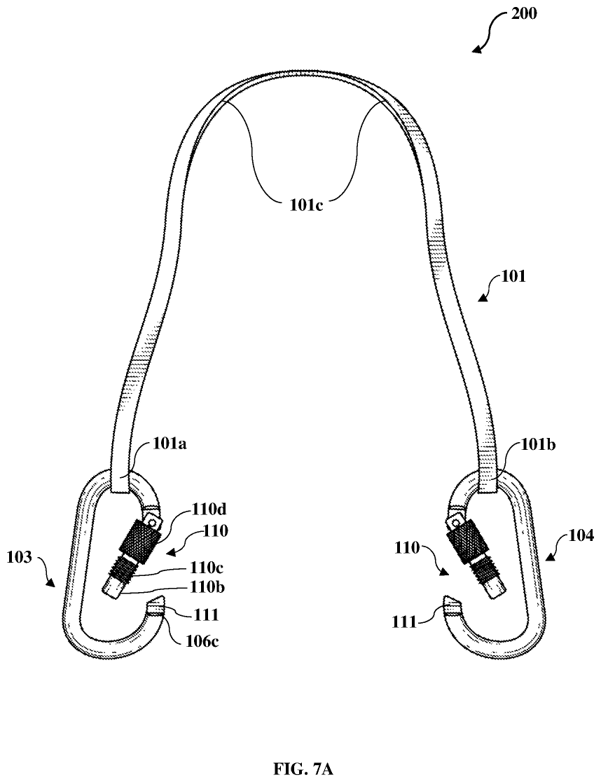

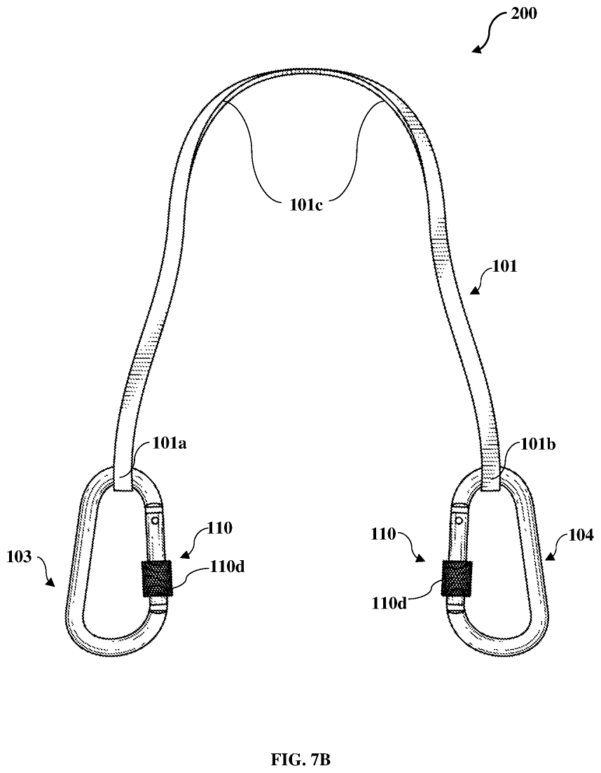

FIG. 7A exemplarily illustrates a top view of an embodiment of the waste moving system 200, showing a latching gate 110 of each of a pair of attachment members 103 and 104 of the second type in an open position. In this embodiment, the attachment members 103 and 104 of the second type are, for example, screw-type locking carabiners, as disclosed in the detailed description of FIG. 2A. The latching gate 110 is opened by unscrewing the locking sleeve 110d from the threaded section 110c of the latching gate 110 and from the nose 111 of each of the attachment members 103 and 104.

FIG. 7B exemplarily illustrates a top view of the waste moving system 200, showing the latching gate 110 of each of the attachment members 103 and 104 of the second type in a closed position. In an embodiment, the latching gate 110 is closed by engaging the second end 110b of the latching gate 110 with the nose 111 exemplarily illustrated in FIG. 7A, and manually screwing the locking sleeve 110d over the threaded section 110c of the latching gate 110 till the locking sleeve 110d reaches the opposing end 106c of the respective attachment member 103 or 104 as disclosed in the detailed description of FIGS. 2A-2B.

FIGS. 8A-8B exemplarily illustrate a schematic embodiment of a method for moving a waste container 506, for example, a wheelie bin, from a waste container staging location 509 to a waste pick-up location 510 distant from the waste container staging location 509 shown in FIG. 5F. As exemplarily illustrated in FIG. 8A, the cable 101 of the waste moving system 200 is disposed in a predefined configuration, for example, a U-shaped configuration, on a base 503 of a trunk 502 of a vehicle 501, for example, a car, as exemplarily illustrated in FIG. 8A. By closing the lid 504 of the trunk 502 over the mid-section 101c of the cable 101 and sandwiching the cable 101 between the lid 504 of the trunk 502 and the base 503 of the trunk 502, the cable 101 is directly secured to the base 503 of the trunk 502, with the opposing distal ends 101a and 101b of the cable 101 and their attachment members 103 and 104 extending freely external to the trunk 502 as exemplarily illustrated in FIGS. 8A-8B. The opposing distal ends 101a and 101b of the cable 101 with their attachment members 103 and 104 respectively, extend freely external to the trunk 502 outside the sandwich interface 505 as exemplarily illustrated in FIG. 8A, with the mid-section 101c of the cable 101 extending inside the trunk 502 of the vehicle 501 as exemplarily illustrated in FIG. 8B.

Each of the attachment members 103 and 104 is detachably connected to a connection element 507, for example, a handle or a slot, of a waste container 506 positioned at the waste container staging location 509 as exemplarily illustrated in FIG. 8B and as disclosed in the detailed description of FIGS. 5A-5F. Connecting the attachment members 103 and 104 to the connection element 507 of the waste container 506 allows the cable 101 hitched to the trunk 502 of the vehicle 501 to pull and move the waste container 506 from the waste container staging location 509 to the waste pick-up location 510, when the vehicle 501 is driven to the waste pick-up location 510 as exemplarily illustrated in FIG. 5F. The wheels 508 of the waste container 506 allow the vehicle 501 to tow the waste container 506 on a road 511 towards the waste pick-up location 510 as exemplarily illustrated in FIG. 5F.

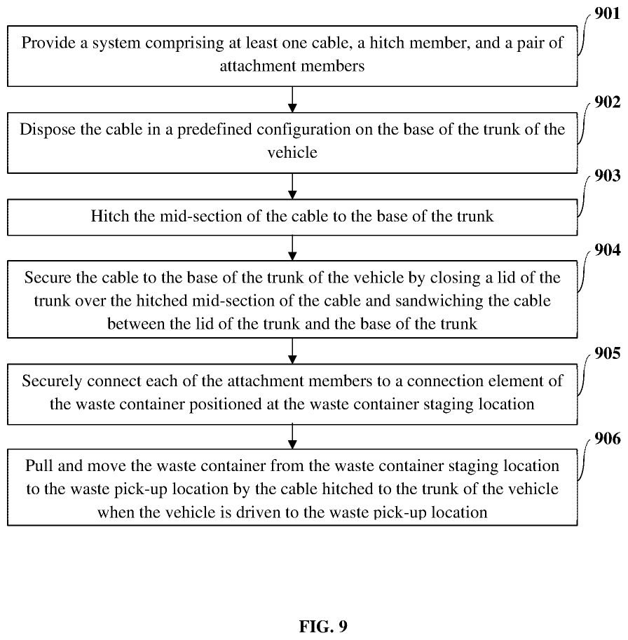

FIG. 9 illustrates a flowchart of a method for moving one or more waste containers 506 from a waste container staging location 509 to a waste pick-up location 510 distant from the waste container staging location 509 shown in FIG. 5F. The method disclosed herein provides 901 the waste moving system 100 comprising at least one cable 101, the hitch member 102, and the pair of attachment members 103 and 104 exemplarily illustrated in FIGS. 1A-4 and as disclosed in the detailed descriptions of FIGS. 1A-4. In the method disclosed herein, the cable 101 is disposed 902 in a predefined configuration, for example, a U-shaped configuration, on the base 503 of the trunk 502 of the vehicle 501 as exemplarily illustrated in FIGS. 5A-5B. The mid-section 101c of the cable 101 is disposed on the base 503 of the trunk 502, with the opposing distal ends 101a and 101b of the cable 101 extending freely external to the trunk 502. In an embodiment, the length of the cable 101 is adjustable using the adjustment member 112 positioned proximal to at least one of the opposing distal ends 101a and 101b of the cable 101 as exemplarily illustrated in FIG. 3. The hitch member 102 hitches 903 the mid-section 101c of the cable 101 to the base 503 of the trunk 502 as exemplarily illustrated in FIGS. 5A-5B and FIG. 5E. The cable 101 is secured 904 to the base 503 of the trunk 502 of the vehicle 501 by closing the lid 504 of the trunk 502 over the hitched mid-section 101c of the cable 101 and sandwiching the cable 101 between the lid 504 of the trunk 502 and the base 503 of the trunk 502 as exemplarily illustrated in FIGS. 5C-5E.

When the lid 504 of the trunk 502 is in a closed position, the hitch member 102 is positioned flush against an inner surface 504a of the lid 504 and the base 503 of the trunk 502, thereby hitching the mid-section 101c of the cable 101 to the base 503 of the trunk 502 as exemplarily illustrated in FIG. 5E. In an embodiment, the cable 101 is directly secured to the base 503 of the trunk 502, without the hitch member 102, by closing the lid 504 of the trunk 502 over the mid-section 101c of the cable 101 and sandwiching the cable 101 between the lid 504 of the trunk 502 and the base 503 of the trunk 502 as exemplarily illustrated in FIGS. 6A-6C and FIGS. 8A-8B. In this embodiment, the mid-section 101c of the cable 101 extends freely inside the trunk 502, with the opposing distal ends 101a and 101b of the cable 101 extending freely external to the trunk 502 as exemplarily illustrated in FIG. 8B. In the method disclosed herein, each of the attachment members 103 and 104 is then securely connected 905 to a connection element 507 of a waste container(s) 506, for example, a wheelie bin containing waste, positioned at the waste container staging location 509 as exemplarily illustrated in FIG. 5A and FIGS. 5D-5E. When the vehicle 501 is driven to the waste pick-up location 510, the cable 101 hitched to the trunk 502 of the vehicle 501 pulls and moves 906 the waste container(s) 506 from the waste container staging location 509 to the waste pick-up location 510 as exemplarily illustrated in FIG. 5F.

The system 100 or 200 and the method disclosed herein are useful in areas where the waste container staging location 509, for example, the location where one or more waste containers 506 are staged, is substantially distant from the waste pick-up location 510 where a waste pick-up vehicle stops to pick up waste from the waste container(s) 506. The system 100 or 200 and the method disclosed herein aid persons who are old, weak, or disabled, to move waste containers 506 from their houses to a distant road in front of their houses where the waste pick-up vehicle stops to pick up the waste from their houses.

The foregoing examples and illustrative implementations of various embodiments have been provided merely for explanation and are in no way to be construed as limiting of the embodiments disclosed herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

I claim:

1. A system for moving one or more waste containers from a waste container staging location to a waste pick-up location distant from the waste container staging location, the system comprising:
at least one cable disposed in a predefined configuration on a base of a trunk of a vehicle, the at least one cable comprising opposing distal ends and a mid-section defined as a section about midway between the opposing distal ends;
a hitch member in communication with the mid-section of the at least one cable, wherein the hitch member is configured to hitch the mid-section of the at least one cable to the base of the trunk, with the opposing distal ends of the at least one cable extending freely external to the trunk; and
a pair of attachment members attached to the opposing distal ends of the at least one cable, wherein each of the attachment members is configured to detachably connect to a connection element of each of the one or more waste containers positioned at the waste container staging location and allow the at least one cable hitched to the trunk of the vehicle to pull and move the one or more waste containers from the waste container staging location to the waste pick-up location when the vehicle is driven to the waste pick-up location.

2. The system of claim 1, wherein the predefined configuration of the at least one cable is a U-shaped configuration.

3. The system of claim 1, wherein the at least one cable is secured to the base of the trunk of the vehicle by closing a lid of the trunk over the mid-section of the at least one cable and sandwiching the at least one cable between the lid of the trunk and the base of the trunk.

4. The system of claim 1, wherein the hitch member is a spherical object in communication with the mid-section of the at least one cable.

5. The system of claim 1, wherein each of the attachment members is a hook-type attachment member comprising a latching gate configured to secure and preclude disengagement of the connection element of the each of the one or more waste containers from the each of the attachment members in a closed position.

6. The system of claim 1, further comprising an adjustment member positioned proximal to at least one of the opposing distal ends of the at least one cable, wherein the adjustment member is configured to adjust a length of the at least one cable.

7. The system of claim 1, further comprising a protective casing configured to enclose and protect each of the attachment members when the attachment members are not in use.

8. The system of claim 1, wherein the opposing distal ends of the at least one cable are attached to the attachment members using fasteners.

9. A system for moving one or more waste containers from a waste container staging location to a waste pick-up location distant from the waste container staging location, the system comprising:
at least one cable disposed in a predefined configuration on a base of a trunk of a vehicle, the at least one cable comprising opposing distal ends and a mid-section defined as a section about midway between the opposing distal ends, wherein the at least one cable is secured to the base of the trunk by closing a lid of the trunk over the mid-section of the at least one cable and sandwiching the at least one cable between the lid of the trunk and the base of the trunk, and wherein the opposing distal ends of the at least one cable extend freely external to the trunk; and
a pair of attachment members attached to the opposing distal ends of the at least one cable, wherein each of the attachment members is configured to detachably connect to a connection element of each of the one or more waste containers positioned at the waste container staging location and allow the at least one cable hitched to the trunk of the vehicle to pull and move the one or more waste containers from the waste container staging location to the waste pick-up location when the vehicle is driven to the waste pick-up location.

10. The system of claim 9, wherein the predefined configuration of the at least one cable is a U-shaped configuration.

11. The system of claim 9, wherein each of the attachment members is a hook-type attachment member comprising a latching gate configured to secure and preclude disengagement of the connection element of the each of the one or more waste containers from the each of the attachment members in a closed position.

12. The system of claim 9, further comprising an adjustment member positioned proximal to at least one of the opposing distal ends of the at least one cable, wherein the adjustment member is configured to adjust a length of the at least one cable.

13. The system of claim 9, further comprising a protective casing configured to enclose and protect each of the attachment members when the attachment members are not in use.

14. A method for moving one or more waste containers from a waste container staging location to a waste pick-up location distant from the waste container staging location, the method comprising:
providing a system comprising at least one cable, a hitch member, and a pair of attachment members, wherein the at least one cable comprises opposing distal ends and a mid-section defined as a section about midway between the opposing distal ends, and wherein the hitch member is in communication with the mid-section of the at least one cable, and wherein the pair of attachment members are attached to the opposing distal ends of the at least one cable;
disposing the at least one cable in a predefined configuration on a base of a trunk of a vehicle, wherein the mid-section of the at least one cable is disposed on the base of the trunk, with the opposing distal ends of the at least one cable extending freely external to the trunk;
hitching the mid-section of the at least one cable to the base of the trunk by the hitch member;
securing the at least one cable to the base of the trunk of the vehicle by closing a lid of the trunk over the hitched mid-section of the at least one cable and sandwiching the at least one cable between the lid of the trunk and the base of the trunk;
securely connecting each of the attachment members to a connection element of each of the one or more waste containers positioned at the waste container staging location; and
pulling and moving the one or more waste containers from the waste container staging location to the waste pick-up location by the at least one cable hitched to the trunk of the vehicle when the vehicle is driven to the waste pick-up location.

15. The method of claim 14, wherein the predefined configuration of the at least one cable is a U-shaped configuration.

16. The method of claim 14, wherein the hitch member is a spherical object in communication with the mid-section of the at least one cable.

17. The method of claim 14, wherein each of the attachment members is a hook-type attachment member comprising a latching gate configured to secure and preclude disengagement of the connection element of the each of the one or more waste containers from the each of the attachment members in a closed position.

18. The method of claim 14, further comprising adjusting a length of the at least one cable using an adjustment member positioned proximal to at least one of the opposing distal ends of the at least one cable.

19. The method of claim 14, wherein the system further comprises a protective casing configured to enclose and protect each of the attachment members when the attachment members are not in use.
